(19) United States
(12) Patent Application Publication
(10) Pub. No.: US 2003/0191870 A1
(43) Pub. Date: Oct. 9, 2003

(54) Method and apparatus for updating software libraries

(76) Inventor: Dominic Duggan, Maplewood, NJ (US)

Correspondence Address: WOLFF & SAMSON, P.C., ONE BOLAND DRIVE, WEST ORANGE, NJ, 07052, US

(21) Appl. No.: 10/114,338

(22) Filed: Apr. 2, 2002

(51) Int. Cl. G06F 9/00; G06F 9/44

(52) U.S. Cl. 709/331; 709/315

(57) ABSTRACT

A method for hot swapping software libraries with dynamic version changes is provided. A sub-type relationship is defined between objects of an existing software library and an updated software library on a computer system, and optionally, subtype relationships are defined between objects of the updated software library and the existing software library to provide backward compatibility. A version adapter is defined for adapting objects for use by the updated software library, and stored in a table of version adapters. The updated software library replaces the existing software library. Existing client threads can continue to pass objects to the updated software library without experiencing a loss of service. Objects incompatible with the updated software library or the existing software library are identified at run-time, and a query is performed into the table of version adapters. A version adapter is retrieved from the table, and applied to the incompatible objects to produce proxy objects having values expected by the software libraries and compatible therewith. The software libraries access the proxy objects to provide continued service to the threads.

### BACKGROUND OF THE INVENTION

1. Field of the Invention

The present invention relates to supporting updates in software libraries, and more specifically, to a method and apparatus for updating software libraries with dynamic version changes.

2. Related Art

Software libraries represent a critical part of modem information systems and technology, and provide necessary services for a multitude of users, ranging from individual users (i.e., users of personal computers) to large enterprises. For example, individual users may rely heavily upon personal productivity software, such as word processors and spreadsheets, while large entities may extensively use database and rapid application development software. Because of the dynamic and often short-lived nature of software, programmers, systems administrators, and other individuals continually update software libraries to include added functionality and to fix software bugs in existing software libraries.

However, when such updates occur, conflicts between the updated and original versions of software can occur, and services provided to the users by the software libraries are frequently disrupted. Further, when software libraries are updated on individual computer systems such as PCs, the user is frequently required to re-boot the system so that functionality of the updated software library can be realized. Such a requirement represents a time-consuming and frustrating task that may, in many instances, be unacceptable to certain users, particularly large entities and organizations. For example, service interruptions are not tolerable in an e-commerce enterprise that relies on servers being available “24/7,” wherein the servers cannot be brought down for version changes in the software. Instead the version changes must be performed “hot” while the server continues to run. Accordingly, the need arises to provide a methodology that allows software to be updated dynamically, without incurring the aforementioned losses of service.

A particular example of the problems associated with software library updates exists in the realm of object-oriented programming. Object-oriented programming languages have quickly become a standard in the computer science and software engineering communities for developing complex software systems. Various operating systems and graphical user interfaces, coded in object-oriented languages such as C++ and Java (a registered trademark of Sun Microsystems, Inc.), incorporate dynamic linking of program libraries as fundamental parts of run-time execution. Present object-oriented programming languages, however, lack the ability to “hot swap” a running software library, wherein the implementation of a software module can be changed during program execution without affecting threads (i.e., programs and/or processes running on one or more computer systems) accessing the software library or requiring re-starting of same. Indeed, with present systems, when an implementation of a software library is updated (i.e., from old to new versions, and vice-versa), threads executing on a client or server machine and accessing the software library prior to the update may experience a disruption in service after the update occurs. Further, present object-oriented languages do not adequately allow different versions of code to handle different versions of objects. Additionally, object-oriented languages only allow for limited version changes that can only be effectuated via inheritance. An example of current object-oriented systems is shown in FIG. 1a. A superclass 10, representing an initial library of code, data structures, and objects, may have an initial object 15a produced by the superclass 10. Thread 20a can then interact with an object 15a via pointer 25a. Thread 20a can execute on the same computer system as object 15a, or on a system separate therefrom.

As shown in FIG. 1b, current object-oriented systems provide a limited mechanism for allowing software libraries to be updated. For example, when a library update occurs, a subclass 30, representing a new library of code, data structures, or objects not existing in superclass 10, may be established as a subtype of superclass 10, and may inherit certain code and objects of superclass 10. A new object 15b can then be produced by subclass 30. According to current object-oriented methodologies, new thread 20b can interact with object 15b via a new pointer 25b established therebetween. Further, new thread 20b can interact with object 15b via new pointer 25c. Thus, as can be seen in FIG. 1b, a client may have both old and new version objects, in addition to new and old version code, existing on the same system.

Through inheritance, current object-oriented methodologies allow old versions of code to access new version objects, wherein data types and other attributes of the objects are compatible with the updated library code. For example, as shown in FIG. 1c, after a library update has occurred, subclass 30 may be established as a subtype of superclass 10. New thread 20b can communicate with object 15b via pointer 25b. New object 15b, via interaction 37, can access code 35 inherited from superclass 10 into subclass 30. Thus, an old version of code (i.e., in superclass 10), can access a new version object (i.e., new object 15b). Type safety is provided for because of the limited changes allowed by inheritance. Old versions of code can operate safely on new version objects, because the latter are only extensions of old version objects.

Further, as shown in FIG. 1d, current object-oriented methodologies do not allow a new version of code to access an old version object with guaranteed type safety. After a library update, subclass 30 is asserted as a subtype of superclass 10. Thread 20a establishes a pointer 25a to an object of superclass 10, allowing interaction therebetween. Thread 20a also establishes a connection 26 with the software library, which has been updated by subclass 30 to expect only objects generated by subclass 30. When code of subclass 30 is applied to object 15a of superclass 10, a downcast procedure 38 is applied to object 15a. However, a downcast failure 40 can occur. Such failure results in the object 15a not having types compatible with code of subclass 30, thereby failing to provide guaranteed type safety. Further, thread 20a is left with a loss of service, because it cannot use the new version code (i.e., code of subclass 30 that has been installed by the library update) with old version objects (i.e., object 15a of superclass 10).

An example of the problems associated with downcast failures illustrated in FIG. 1d can be appreciated with reference to the Java code portion reproduced in Table 1, below:

TABLE 1

class T { ... };
class NewT extends T { ... };
interface TLibrary {

T get ();
T combine (T x, T y);

| }; | |
|---|---|
| static TLibrary library; | |
| T x = library.get (); | // Old version of type T |
| | // Software update happens here |
| T y = library.get (); | // New version of type NewT |
| T z = library.combine(x,y); | // Which version? |

The library object of Table 1 represents a pointer to a library. The library object provides a “get” operation for creating objects of type T. The “get” operation obtains a T object, while the “combine” operation combines the objects obtained by “get.” For example, the library object could be a file system, the “get” operation a file open operation, an object of type “T” an open file object, and “combine” any operation for combining files, such as file concatenation. A library update replaces this library object; the new library object returns objects of type NewT, with type upcast to supertype T for clients. The “combine” operation will then have to downcast its arguments to type T. After the software update occurs, one or more client threads may have a value of the old implementation type on the respective thread stacks, and may provide this old version to the operations of the new implementation; the downcast in the “combine” operation will then fail. Further, it is possible for the client thread to be executing code from the old implementation, perhaps in a long-lived loop, so that the old version code obtains new version values.

In current object-oriented systems, the downcast errors illustrated in FIG. 1d can be overcome in limited circumstances. For example, a programmer may put file system code into open file objects as methods, so that there is guaranteed to be a version match between the code executing and the object (the code is part of the object). However, this approach only works when the version of only one argument of a library operation changes (for example, “read” and “write” operations for open file objects), and fails when there are operations in the library code that require two or more arguments of the same version (for example, “concatenation” for open file objects). This is illustrated in Table 2 below, where “combine” is made into a method of the T objects:

TABLE 2

class T { T combine (T x); ... };
class NewT extends T {

T combine (T x) { NewT x2 = (NewT)x; ... } ...

};
interface TLibrary {

T get ();

| }; | |
|---|---|
| static TLibrary library; | |
| T x = library.get (); | // Old version of type T |
| | // Software update happens here |
| T y = library.get(); | // New version of type NewT |
| T z = y.combine(x); | // Which version? |

Therefore, there is a need to dynamically adapt objects for use with library code installed as a result of a software update, so that all method types of the library code operate properly with objects. A variety of methodologies have been developed to attempt to provide hot swapping of running modules, using, for example, version barriers, views, and global updates. None of these approaches, however, provide a reliable mechanism for hot swapping of software libraries where types in the libraries change, wherein existing client threads are undisturbed by the software update. Nor do such approaches guarantee type safety between objects and software libraries, and prevent downcast errors.

Accordingly, what would be desirable, but has not yet been provided, is a method for hot swapping software libraries with dynamic version changes.

### OBJECTS AND SUMMARY OF THE INVENTION

It is an object of the present invention to provide a method for hot swapping software libraries with dynamic version changes.

It is another object of the present invention to provide a method for hot swapping software libraries with dynamic version changes that can be implemented by extending existing object-oriented programming languages.

It is a further object of the present invention to provide a method for hot swapping software libraries that dynamically and lazily applies version adapters to objects during program execution.

It is still another object of the present invention to provide a method for hot swapping software libraries that utilizes a table of version adapters to construct proxy objects having expected versions from objects of actual versions.

It is yet another object of the present invention to provide a method of adapting a superclass object for use by subclass code.

It is even another object of the present invention to provide a method for hot swapping software libraries with dynamic version changes that provides type safety.

It is an object of the present invention to provide a method for hot swapping software libraries that prevents downcast errors between objects and software libraries.

The present invention relates to a method for hot-swapping software libraries with dynamic version changes. Data structures, represented as objects, are dynamically adapted from actual versions to expected versions as required by updated library code. A subtype relationship is asserted between a first version library and a second version library, and a version adapter for building a proxy object having an expected value is associated with the relationship. Run-time type tags are associated with objects produced by the libraries. The relationship, in conjunction with the version adapter, is stored in a table of version adapters when the library update occurs. After the update, when an object produced by the first version library (i.e., an object produced by a superclass) is passed to code of the second version library (i.e., a subclass), a version check is performed. If the object is of the version expected by the code of the second version library, the object is passed to the code for processing. Otherwise, a lookup is initiated in the version adapter table, and an appropriate version adapter is selected from the version table. Then, a proxy object is constructed from the object using the version adapter and one or more run-time type tags associated with the object, the proxy object having values expected by the code of the second version library. Different versions of code can operate reliably with new and old version objects, thereby preventing disruption of client threads when the update occurs.

The present invention also includes a method for preventing downcast errors in software libraries by dynamically adapting superclass objects for use with subclass code in instances where old version and new version mismatches occur. A superclass object passed to subclass code is analyzed to determine wither the object has a version compatible with the code. If compatibility between the superclass object and the subclass code does not exist, the present invention retrieves a version adapter from a table of version adapters, and applies same to the object to produce a proxy object having properties compatible with the subclass code. Thus, by dynamically adapting objects passed to subclass code, the present invention prevents downcast errors and ensures compatibility between objects and updated software libraries. Further, by preventing downcast errors, the present invention ensures that type safety is maintained between existing and updated software libraries.

### BRIEF DESCRIPTION OF THE DRAWINGS

Other important objects and features of the invention will be apparent from the following Detailed Description of the Invention taken in connection with the accompanying drawings in which:

FIG. 1a is a diagram showing an example of a library update procedure and resulting class, object, and thread interactions achieved by the prior art.

FIGS. 1b and 1c are diagrams showing examples of prior art interactions between inherited superclass code and subclass objects occurring after the update of FIG. 1a.

FIG. 1d is a diagram showing an example of a loss of service experienced by threads in the prior art, after a library update has occurred.

FIG. 2 is a diagram showing the methodology of the present invention, wherein an object adaptation operation and a table of version adapters provide a proxy object for use by subclass code and existing client threads.

FIG. 3 is a diagram showing the methodology of the present invention in greater detail.

FIG. 4 is a diagram showing the methodology of the present invention for adapting an old version object for use with new version code.

FIG. 5 is a flowchart showing processes for generating version adapter information and storing same in the version adapter table of the present invention.

FIG. 6 is a flowchart showing run-time processes for adapting an object for use by a program, using the version adapter table and version adapter of the present invention.

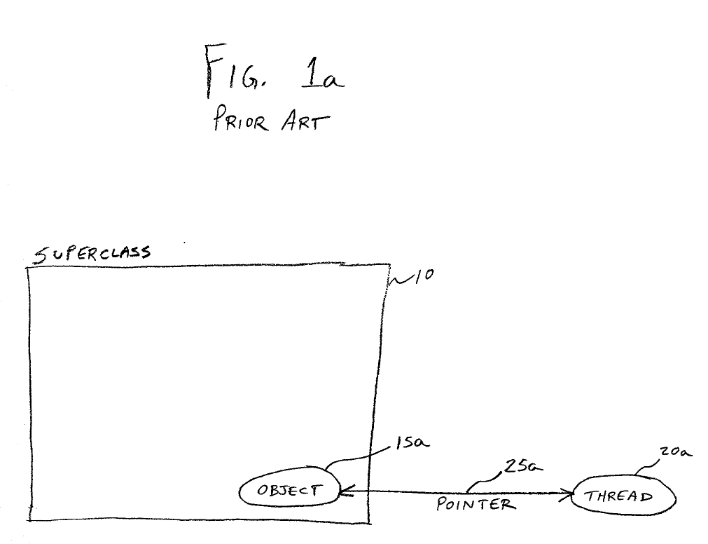

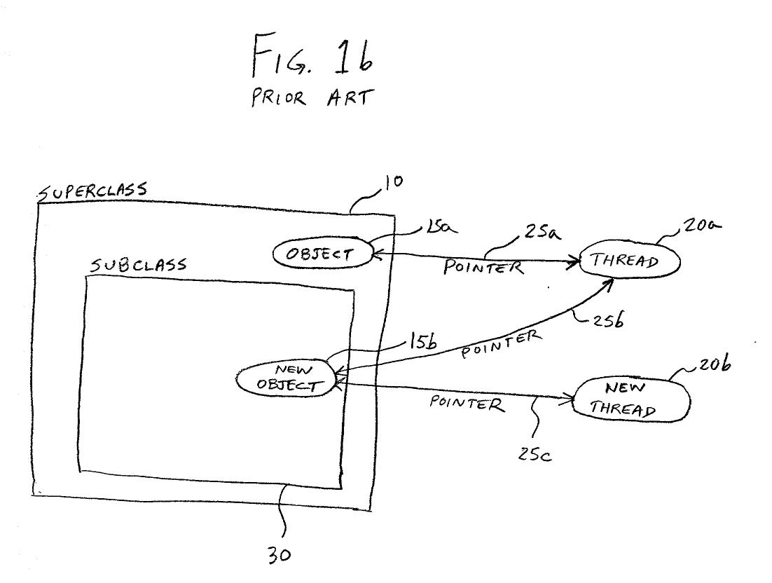

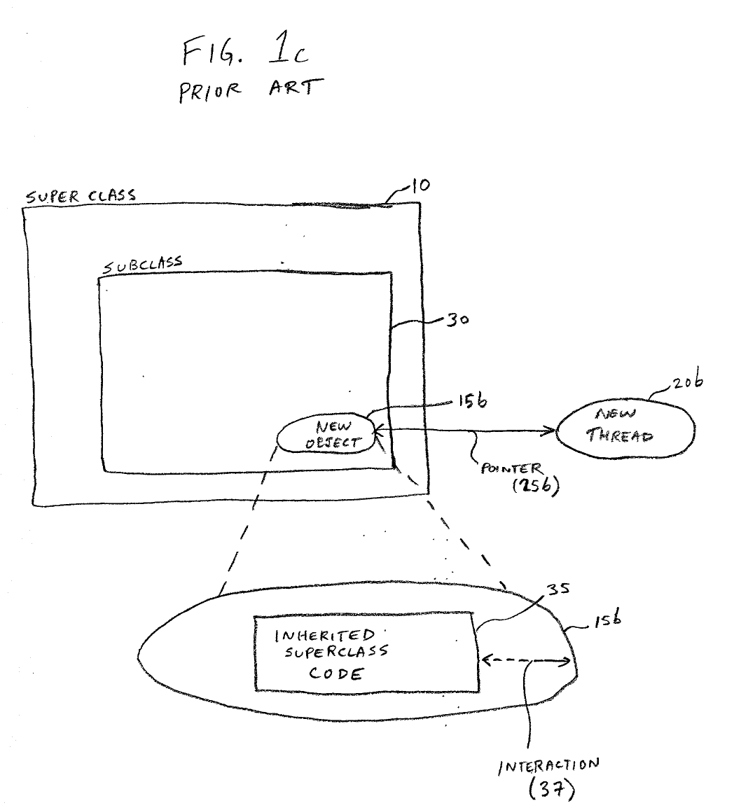

### DETAILED DESCRIPTION OF THE INVENTION

The present invention relates to a method for supporting dynamic version changes for hot-swapping of software libraries. Objects produced by a first version of software can be dynamically and lazily adapted (i.e., objects are only adapted if and when necessary) for use by later versions of software, so that client threads accessing the objects and the later versions of software do not experience a disruption in service. The methodology of the invention allows for version changes in software beyond the inheritance paradigm of present object-oriented languages, since inheritance only provides for limited version changes and only allows old versions of software to access new version objects. Further, the methodology allows new methods and interfaces not provided with legacy objects to be used by the legacy objects.

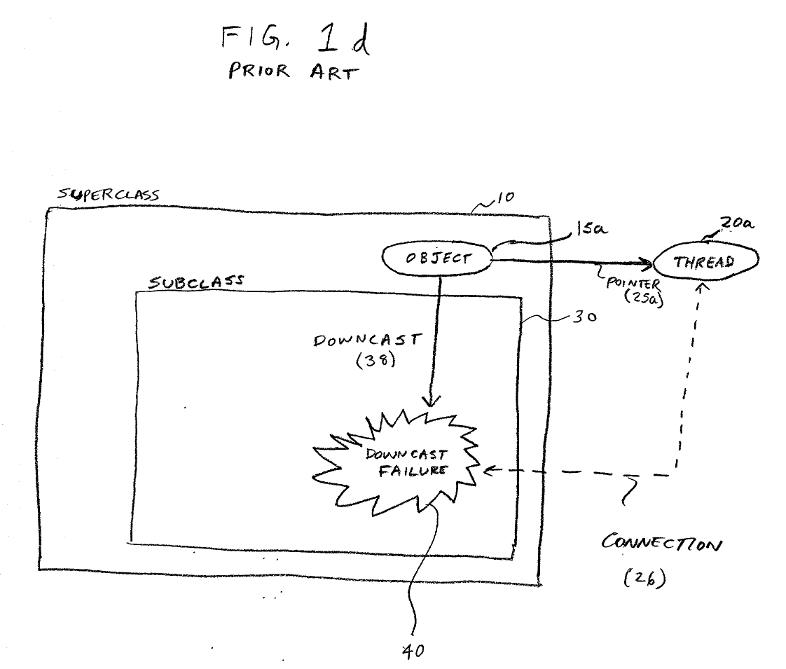

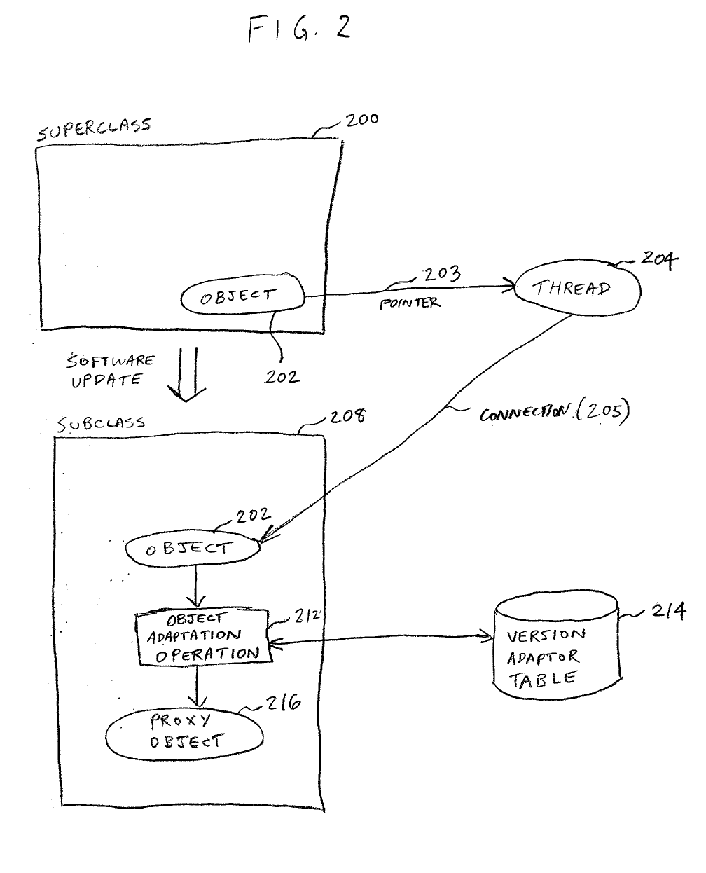

FIG. 2 is a diagram showing the methodology of the present invention, wherein an object adaptation operation and a table of version adapters provide a proxy object for use by subclass code and existing client threads. Superclass 200, representing a software library existing on any computer system known in the art, produces an object 202, which can be any data object, structure, or associated methods and procedures. The object 202 can then be accessed by thread 204 by pointer 203. Thread 204 can be any computer process running on any computer system, and can even be a process running on the same computer system on which object 202 exists.

Subclass 208 contains code not existent in superclass 200, and is introduced into software library 200 by a software update. Subclass 208 includes procedures that may inherit functionality from procedures of superclass 200, using the object-oriented paradigm of inheritance. When the object 202 produced by superclass 200 is passed to code of subclass 208 by thread 204 via connection 205, or the code of subclass 208 is otherwise applied to object 202, the traditional downcast procedure, which, as described earlier, results in a downcast failure of object 202, is bypassed by the present invention. Rather, object 202 is passed to object adaptation operation 212. Object adaptation operation 212 then performs a query into version adapter table 214 to retrieve a coercion function (version adaptor) from version adapter table 214, based upon run-time type tags associated with object 202. Version adapter table 214 can be any data structure capable of allowing a query for one field (i.e., a version adapter), based upon the values of two or more other fields (i.e., type tags). Further, the version adapter table of the present invention can be a hash table, splay tree, array, list, 2-3 tree, or any other data structure known in the art.

Once acquired, the version adaptor is applied by object adaptation operation 212 to object 202, to produce proxy object 216. Proxy object 216 contains all attributes (i.e., fields, types, values, or other properties) required by subclass 208, so that code of subclass 208 can process object 202 without failure. Thus, the library update does not disrupt thread 204, because thread 204 can continue to send objects of superclass 200 (i.e., objects produced by an older version of the library prior to the update) to code of subclass 208.

An important aspect of the present invention is the ability to dynamically apply version adapters to objects. When an object of the superclass is passed to code of the subclass, it may not be necessary to produce a proxy object. For example, if the object passed to the subclass is compatible therewith (i.e., already contains all fields and/or data types expected by the subclass), a proxy object is not required. Accordingly, the present invention includes logic for determining when a proxy object should be constructed from an actual object.

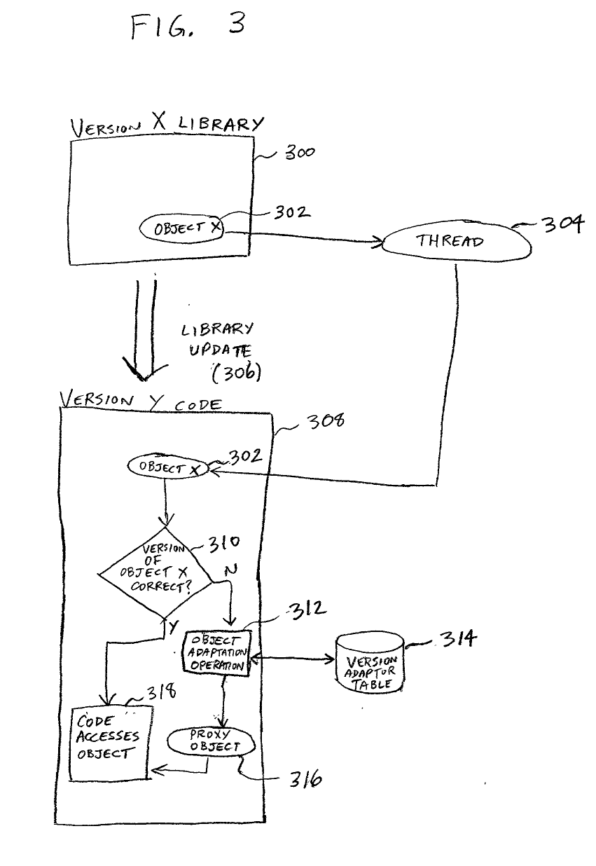

FIG. 3 is a diagram showing the methodology of the present invention in greater detail. Version X library 300 represents a software library executing on a computer system. Object X 302 is produced by version X library 300, and communicates with thread 304, executing on any computer system. Thread 304 then passes object X 302 to version Y code 308. Version Y code 308 represents software installed as a result of a library update 306. Version Y library 308 may be a subclass of version X library 300, although the invention allows arbitrary version changes in addition to the version changes allowed by inheritance. When object X 302 is passed to version Y code 308, a decision point is reached at step 310, wherein a determination is made as to whether object X 302 is of a version compatible with version Y code 308. The version of object X 302 can be indicated by a run-time type tag attached thereto, or by any other version indicator known in the art, such as a field.

If a negative determination is made by step 310 (i.e., object X 302 is not of a version compatible with version Y code 308), object X 302 is passed to object adaptation operation 312. Object adaptation operation 312 then queries version adapter table 314 for a coercion method (i.e., version adapter) F( ) corresponding to one or more type tags associated with object X 302. In a preferred embodiment of the present invention, version adapter table 314 is indexed according to version type mappings between superclass (i.e., version X library) and subclass (i.e., version Y library) elements, illustratively designated as types T₁ and T₂, respectively. The structure of version adapter table 314, in addition to coercion methods and type indices stored therein, will be discussed below in greater detail.

When the corresponding coercion method F( ) has been retrieved from version adapter table 314, it is applied to object X 302 by object adaptation operation 312 to produce proxy object 316. Proxy object 316 is compatible with version Y code 308, and contains all fields, types, values, or other properties expected by version Y code 308. Then, proxy object 316 is passed to version Y code 308 by step 318, wherein proxy object 316 is accessed by the code.

In the event that a positive determination is made by step 310 (i.e., object X 302 has a version compatible with version Y code 308), object X 302 is passed directly to version Y code 308 in step 318 for processing thereby. Therefore, because of the ability to determine whether objects passed to subclass code are of the correct version or require adaptation, the present invention dynamically adapts objects as required by subclass code. A client thread accessing an object can pass the object to subclass code, without experiencing a loss of service associated with downcasting procedures presently utilized in the art. Further, the dynamic adaptation of objects allows software library updates to occur during program execution (i.e., “hot-swapping”), without affecting client threads.

The methodology disclosed in FIG. 3 can be applied to allow hot-swapping from an old version library to a new version library. In such a situation, objects of the old version library that are passed to the new version library are dynamically adapted for use by the new version library as needed. Thus, if a particular object of the old version library does not require adaptation, it is passed directly to the new version library for use thereby. However, if the object of the old version library is not compatible with the new version library (i.e., has types or other attributes that are not compatible with the new library), a proxy object is produced from the old version object for use with the new version library, the proxy object being compatible with the new version library. This process is referred to as dynamic or “lazy” adaptation.

Further, the methodology disclosed in FIG. 3 can also be applied to adapt new version objects for use with old version libraries that may be existent after a software update from the old version library to the new version library occurs. For example, even though an old version library may be replaced by a new version library, the old version library may still be executing in one or more threads of one or more computer systems running loops of the old version library's code. Thus, the present invention provides the distinct advantage of dynamically (lazily) adapting new version objects for use by such old version libraries.

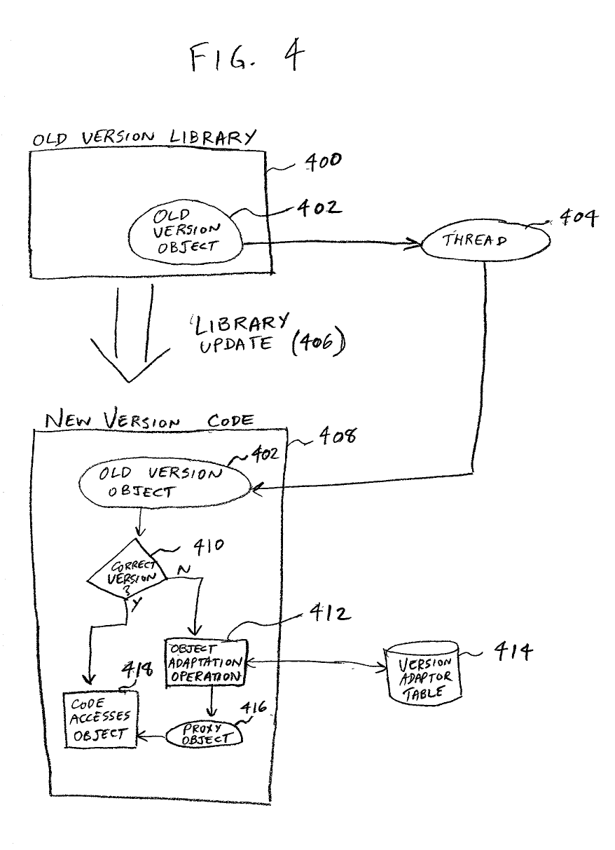

An example of dynamic (lazy) object adaptation of an old version object for use with a new version library is shown in FIG. 4. An old version library 400 produces an old version object 402, utilized by thread 404. After library update 406, new version code 408 replaces old version library 400. Thread 404 passes old version object 402 to new version code 408, whereupon the object is checked in step 410 to determine if the object has a correct version. If not, the old version object 402 is passed to object adaptation operation 412, whereupon an appropriate coercion method is retrieved from version table adapter 414 and applied to old version object 402 to produce proxy object 416. Depending upon whether old version object 402 has the correct version, either old version object 402 or proxy object 416 is passed to new version code 408 in step 418, for use thereby.

Although dynamic (lazy) object adaptation is shown in FIG. 4 for adapting old version objects for use by new version libraries and code, it is to be expressly understood that the present invention can also be used to adapt new version objects for use by old version code. The present invention can be used whenever there is a version mismatch between library code (i.e., wherein the library has version X) and an object produced by another version of that library (i.e., wherein the object has version Y). Accordingly, the present invention allows an old version object to be operated upon by a new version library, and a new version object to be operated upon by an old version library.

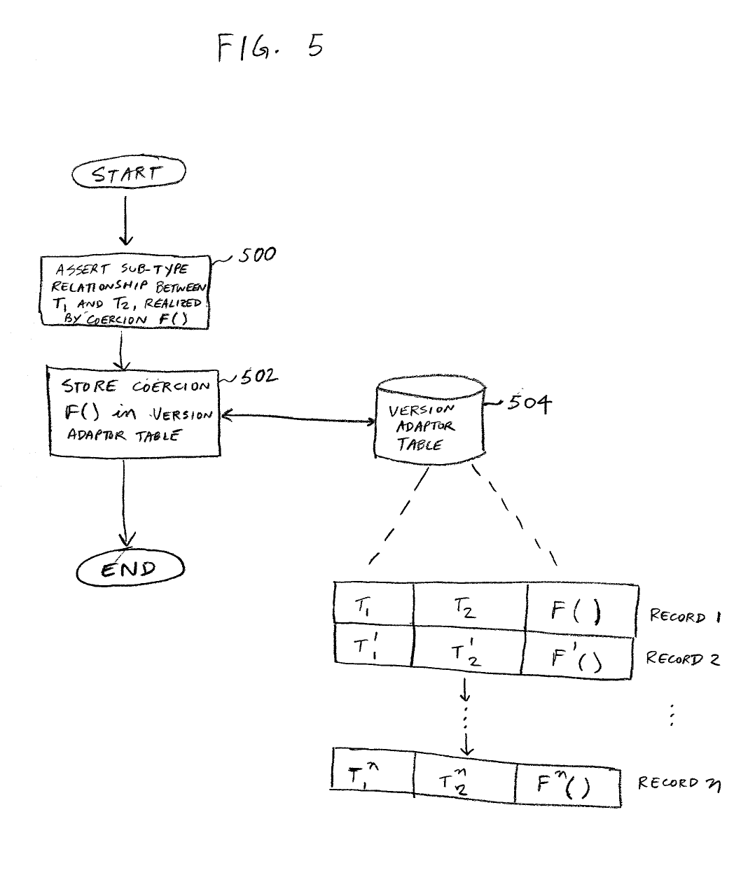

FIG. 5 is a flowchart showing processes for generating and storing version adapter information in the version adapter table of the present invention. As mentioned earlier, version adapters are dynamically applied to objects passed by threads to library code that has been updated, so that the thread does not experience a loss of service, allowing libraries to be hot-swapped. Before the software library is updated, sub-type relationships are asserted between the original and updated software libraries, and appropriate coercion methods are assigned to the relationships. Thus, starting in step 500, when a software library update occurs, a sub-type relationship is asserted between the original library and the updated library, represented by types T₁ and T₂, respectively. Further, a coercion method F( ) is defined and assigned to the relationship. In step 502, the coercion method F( ) is then stored in version adapter table 504, and is indexed by types T₁ and T₂. As shown in the drawing, version adapter table 504 can store a number of records corresponding to a number of sub-type relationships, thereby allowing the present invention to keep track of a variety of software updates occurring on one or more computer systems.

The version adapter of the present invention allows a proxy object having expected values to be produced from an object having actual values. The version adapter can be embodied as a set of methods coded in any object-oriented programming language known in the art. For purposes of illustration, two version adapters for producing proxy objects are listed in the code portions reproduced below:

TABLE 3

class Ipv4packet {

int sourceAddr;
int destAddr;
int checksum;
byte [] payload;

}
class Ipv6packet {

byte [16] sourceAddr;
byte [16] destAddr;
int priority;
byte [] payload;

}
class adapter_Ipv4packet_to_Ipv6packet { // version adapter #1

Ipv6packet adapt (Ipv4packet p) {

Ipv6packet q = new Ipv6packet ();
q.sourceAddr = ... // from p.sourceAddr
q.destAddr = ... // from p.destAddr
q.priority = NORMAL;
q.payload = p.payload;
return q;

}

}
class adapter_Ipv6packet_to_Ipv4packet { // version adapter #2

Ipv4packet adapt (Ipv6packet p) {

Ipv4packet q = new Ipv4packet ();
q.sourceAddr = ... // from p.sourceAddr
q.destAddr = ... // from p.destAddr
q.checksum = ... // compute checksum from p.payload
q.payload = p.payload;
return q;

}

}
//runtime registration of adapters 1 and 2:
Adapter_Ipv4packet_to_Ipv6packet adapter_4_to_6 =

New Adapter_Ipv4packet_to_Ipv6packet ();

Adapter_Ipv6packet_to_Ipv4packet adapter_6_to_4 =

New Adapter_Ipv6packet_to_Ipv4packet ();

Register (Ipv4packet.class, Ipv6packet.class, adapter_4_to_6);
Register (Ipv6packet.class, Ipv4packet.class, adapter_6_to_4);

In the example listed in Table 3, class “Ipv4packet” and class “Ipv6packet” represent class definitions for producing objects having integer and byte values. As can be seen, objects produced by these classes will have different attributes. For purposes of illustration, class “Ipv4packet” produces an object corresponding to a packet utilized by Internet Protocol, version 4 (“Ipv4”). Class “Ipv6packet” produces an object corresponding to a packet utilized by Internet Protocol, version 6 (“Ipv6”). Class “adapter_Ipv4packet_to_Ipv6packet” represents a first version adapter, which produces a proxy object suitable for use by Ipv6 from an object of type Ipv4. Conversely, class “adapter_Ipv6packet_to_IpV4packet” represents a second version adapter, which produces a proxy object suitable for use by Ipv4 from an object of type Ipv6.

When the version adapters have been defined, they are registered with the runtime environment using the identifiers “adapter_{—}4_to_{—}6” and “adapter_{—}6_to_{—}4,” and can be utilized to produce the corresponding proxy objects where necessary. As shown in Table 3, “Ipv4packet.class” represents Java syntax denoting the class metaobject for “Ipv4packet.” Every “Ipv4packet” object has a pointer to this metaobject, which is used as a Java runtime type tag. Similarly, “Ipv6packet.class” represents Java syntax denoting the class metaobject for “Ipv6packet.” Every “Ipv6packet” object has a pointer to the metaobject, which is also used as a Java runtime type tag.

The object adaptation methodology of the present invention can be syntactically represented in the following fashion. Assume C represents a class definition within an object-oriented language, such as Java. The syntax “adaptable C” represents an adaptable version of class C, to which object adaptation can be applied. If some object p has a type “adaptable C,” then, p is a reference to an object that may be of type C or of some other type C0, wherein “adaptable C0” is a subtype of adaptable C. Using such a syntax, subtyping relationships between the objects “Ipv4packet” and “Ipv6packet” produced by the code of Table 3 may be asserted, wherein “adaptable Ipv4packet” is a subtype of “adaptable Ipv6packet,” and “adaptable Ipv6packet” is a subtype of “adaptable Ipv4packet.” Whenever an object of type “adaptable Ipv6packet” is expected in a program, an object of type “adaptable Ipv4packet” can be supplied instead, using the version adapters of Table 3 (i.e., by invoking the “adapt” method of version adapter “adapter_{—}4_to_{—}6”). Similarly, when an object of type “adaptable Ipv4packet” is expected in a program, an object of type “adaptable “Ipv6packet” can be supplied instead, using the version adapter “adapter_{—}6_to_{—}4.”

The syntax “<<C>>p” can be utilized to represent an adaptation operation that returns an object of type C, wherein p is an object of the type “adaptable C.” The adaptation operation checks to see if p is a reference to an object of type C. If it is, then the object of type C is returned. Otherwise, a chain of coercions are applied to adapt the actual type of p to the expected type of C. Such coercions are illustratively indicated in Table 4, using the variable definitions defined in Table 3:

TABLE 4

Ipv4packet p = ...;
adaptable Ipv4packet ap = p;
adaptable Ipv6packet aq = ap;
Ipv6packet q = <<Ipv6packet>> aq;

As shown in Table 4, an assignment of ap to aq is allowed, because of the subtype relationship added by the registrations of Table 3. The adaptation operation then causes the adapter “adapter_{—}4_to_{—}6” to be invoked, and the result stored in q.

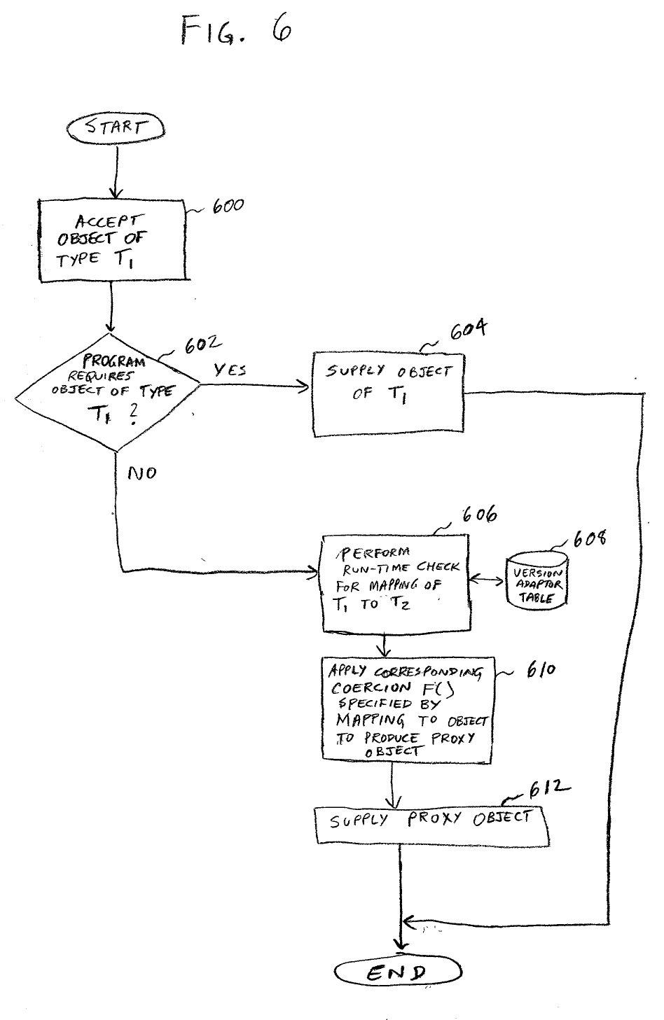

FIG. 6 is a flowchart showing processes for adapting an object for use by a program, using the version adapter table and one or more version adapters (i.e., coercion methods) of the present invention. After a library update has occurred, and all associated sub-type relationships and coercion methods have been defined and stored in the version adapter table, the updated library is ready to receive and process objects passed to it by one or more threads. In step 600, an object is received from the thread, having a type tag associated with it (indicated illustratively as type T₁). In step 602, a determination is made as to whether the program to which the object is being passed (i.e., the method specified by the thread and desired to be applied to the object) requires an object having the type specified by the type tag (i.e., type T₁). If a positive determination is made, step 604 is invoked, wherein the object itself, without any modification thereto, is passed directly to the program. Thus, in such an instance, step 602 has determined that the object currently has the correct types, fields, and other parameters required by the program to process same.

In the event that a negative determination is made, step 606 is invoked, wherein a run-time check is performed to find a mapping of T₁ to T₂ in version adapter table 608. T₂ represents the type expected by the program. As mentioned earlier, version adapter table 608 is indexed by T₁ and T₂, thereby allowing a fast query to be performed and the required coercion method (version adapter) F( ) to be retrieved. Once the coercion method F( ) has been retrieved, in step 610, the method is applied to the object to produce a proxy object having the required fields, types, and other parameters required by the program. Then, in step 612, the proxy object is passed to the program, allowing same to seamlessly perform operations on the proxy object. Thus, the client thread does not experience a loss of service, because the original object it passed to the program can be utilized by the program via the proxy object. Library updates can therefore occur at any time, allowing software to be hot-swapped without affecting client threads currently accessing the library.

The object adaptation methodology of the present invention can be expanded to allow adaptation of objects across one or more versions, using one or more version adapters. For example, if a subtype relationship is asserted between a version X object type and a version Y object type, and another subtype relationship is later asserted between a version Y object type and a version Z object type, then a version X object can be adapted for use both by the version Y library and the version Z library. In the case where a version X object is desired to be adapted for use with a version Z library, two version adapters can be applied, wherein the version X object is adapted by a first version adapter to a version Y object, and the version Y object is then adapted by a second version adapter to a version Z object. Both of these version adapters are retrieved from the version adapter table.

Alternatively, a single “composite” adapter can be composed of the first version adapter and the second version adapter to provide a single version adapter capable of adapting a version X object directly for use with a version Z library. Such an adapter may be retrieved from the version adapter table. Composite version adapters could be added to the version adapter table by performing incremental transitive closure (i.e., adding all such composite version adapters that are newly available) when a new version adapter is added to the version adapter table of the present invention. This example can be generalized to any n+1 versions X₁, . . . , Xₙ₊₁ where there are version adapters for adapting version Xᵢ objects to version Xᵢ₊₁ objects, for i=1, . . . , n and n≧1.

Having thus described the invention in detail, it is to be understood that the foregoing description is not intended to limit the spirit and scope thereof. What is desired to be protected by Letters Patent is set forth in the appended claims.

What is claimed is:

1. A method for updating software libraries comprising:
replacing a first software library in a computer system with a second software library;
allowing objects to be passed to the first software library and the second software library by one or more threads;
determining compatible objects from the objects passed by the one or more threads;
producing proxy objects from incompatible objects passed by the one or more threads, the proxy objects being compatible with the first software library and the second software library; and
executing the software libraries with the compatible objects and the proxy objects.

2. The method of claim 1, wherein the step of replacing the first software library with the second software library comprises replacing an old version library with a new version library.

3. The method of claim 1, wherein the step of producing the proxy objects further comprises producing the proxy objects from the incompatible objects as needed.

4. The method of claim 1, wherein the step of producing proxy objects further comprises applying one or more version adapters to the incompatible objects to produce the proxy objects.

5. The method of claim 4, further comprising applying one or more coercion methods stored in the one or more version adapters to the incompatible objects to produce the proxy objects.

6. The method of claim 5, wherein one or more coercion methods produces expected values for the proxy objects from actual values of the incompatible objects, the expected values being compatible with the software libraries.

7. The method of claim 5, further comprising retrieving the one or more version adapters from a table of version adapters.

8. The method of claim 1, further comprising providing continuous service to the one or more threads by selectively adapting additional objects passed by the one or more threads for use with the software libraries.

9. The method of claim 1, further comprising selectively adapting incompatible objects provided by a third version library for use with the first version library or the second version library.

10. A method for updating software libraries comprising:
replacing a second software library with a first software library;
producing one or more version adapters for adapting one or more incompatible objects passed to the software libraries by one or more threads;
storing the one or more version adapters in a table;
allowing the one or more threads to access the software libraries;
selectively applying the one or more version adapters to the one or more incompatible objects to produce proxy objects; and
executing the software libraries with the proxy objects.

11. The method of claim 10, wherein the step of providing the second software library comprises providing a new version library to replace an old version library.

12. The method of claim 10, further comprising continuing to allow successive threads to access the software libraries.

13. The method of claim 10, wherein the step of producing the one or more version adapters comprises defining one or more coercion methods for producing the proxy objects from the incompatible objects.

14. The method of claim 10, wherein the step of selectively applying the one or more version adapters comprises identifying the incompatible objects from a plurality of objects passed to the software libraries from the one or more threads, and applying the one or more version adapters to the incompatible objects.

15. The method of claim 14, further comprising producing expected values for the proxy objects based upon actual values from the incompatible objects, the expected values being compatible with the software libraries.

16. The method of claim 10, further comprising providing continuous service to the one or more threads by selectively adapting additional objects passed by the one or more threads for use with the software libraries.

17. The method of claim 10, further comprising selectively adapting incompatible objects provided by a third software library for use by either the first software library or the second software library.

18. A method of adapting a superclass object for use by subclass code comprising:
determining whether the superclass object has a version incompatible with the subclass code;
in response to a positive determination,
applying one or more version adapters to the superclass object to produce a proxy object, the proxy object being compatible with the subclass code; and
allowing the subclass code to execute using the proxy object; and
in response to a negative determination,
allowing the subclass code to execute using the superclass object.

19. The method of claim 18, wherein the step of applying the one or more version adapters comprises retrieving the one or more version adapters from a table of version adapters at runtime.

20. The method of claim 19, further comprising retrieving one or more coercion methods from the one or more version adapters.

21. The method of claim 20, further comprising applying the one or more coercion methods to the superclass object to produce the proxy object, the proxy object having expected values compatible with the subclass code.

22. A method of preparing an updated software library for hot-swapping in a computer system comprising:
asserting one or more sub-type relationships between the updated software library and an existing software library on the computer system;
producing one or more version adapters for adapting objects for use by the software libraries; and
storing the one or more version adapters in a table of version adapters, the table being indexed by the one or more sub-type relationships.

23. A method of using the second software library of claim 22, further comprising replacing the existing software library with the updated software library.

24. The method of claim 23, further comprising allowing threads to access the updated software library.

25. The method of claim 24, further comprising querying the table of version adapters to retrieve a desired version adapter from the table.

26. The method of claim 25, further comprising applying the desired version adapter to incompatible objects to produce proxy objects for use by the software libraries.

27. A method for updating software libraries comprising:
replacing a version X software library with a version Y software library;
allowing objects to be passed to the version X software library and the version Y software library by one or more threads;
producing proxy objects from incompatible objects passed by the one or more threads, the proxy objects being compatible with the version X software library and the version Y software library; and
executing the version X software library and the version Y software library with the proxy objects.

28. The method of claim 27, wherein the version X software library comprises an old version software library and the version Y software library comprises a new version software library.

29. The method of claim 27, wherein the step of producing proxy objects further comprises producing proxy objects from the incompatible objects as needed.

30. The method of claim 27, further comprising replacing the version Y software library with a version Z software library, and adapting incompatible objects from version X objects or version Y objects or both for use by version Z code.

31. The method of claim 27, further comprising replacing the version Y software library with a version Z software library, and adapting version Z objects for use by version X code or version Y code or both.

32. A method for adapting objects for use by updated software libraries having n versions X₁, . . . , Xₙ₊₁ comprising:
specifying version adapters for adapting version Xᵢ objects to version Xᵢ₊₁ objects and version Xᵢ₊₁ objects to Xᵢ objects, for i=1, . . . , n; and
adapting a version X₁ object to a version Xₙ object or a version Xₙ object to a version X₁ object using the version adapters where the version X₁ object and the version Xₙ object have incompatible versions.

33. The method of claim 32, further comprising storing the version adapters in a version adapter table.

34. A method for updating software libraries having n versions X₁, . . . , Xₙ₊₁ comprising:
replacing a version Xᵢ software library with a version Xᵢ₊₁ software library;
specifying version adapters for adapting version Xᵢ objects to version Xᵢ₊₁ objects and version Xᵢ₊₁ objects to Xᵢ objects, for i=1, . . . , n; and
adapting a version X₁ object to a version Xₙ object or a version Xₙ object to a version X₁ object using the version adapters where the version X₁ object and the version Xₙ object have incompatible versions.

35. The method of claim 34, further comprising storing the version adapters in a version adapter table.

36. A method of allowing a version X object to access version Y code comprising:
determining whether the version X object has a version incompatible with the version Y code;
in response to a positive determination,
applying a version adapter to the version X object to produce a proxy object, the proxy object being compatible with the version Y code; and
allowing the version Y code to execute using the proxy object; and
in response to a negative determination,
allowing the version Y code to execute using the version X object.

37. The method of claim 36, wherein the step of applying the version adapter comprises retrieving the version adapter from a table of version adapters at runtime.

38. The method of claim 37, further comprising retrieving one or more coercion methods from the version adapter.

39. The method of claim 38, further comprising applying the one or more coercion methods to the version X object to produce the proxy object, the proxy object having expected values compatible with the version Y code.
